(19) United States
(12) Patent Application Publication
(10) Pub. No.: US 2006/0094358 A1
(43) Pub. Date: May 4, 2006

(54) High speed voice message retrieval via a phone, and a universal telephone number exchange system

(76) Inventor: Davood Khalili, Santa Clara, CA (US)

Correspondence Address: DAVOOD KHALILI, P. O. BOX 743, SANTA CLARA, CA, 95052, US

(21) Appl. No.: 10/977,299

(22) Filed: Nov. 1, 2004

(51) Int. Cl. H04B 7/00

(52) U.S. Cl. 455/41.2

(57) ABSTRACT

A system consisting of hand phones (Cellular) allowing wireless means, to transmit and receive owners' phone numbers within a short range without using any telephone service and also allowing the phone to download messages from voice mail system or an answering machine that saves the messages in MP3 or any other encoded or zipped format for reduction of time of download specially for long distance users accessing home.

### BACKGROUND OF TH INVENTION

The retrieval of messages for travelers using a regular wall phone or a cellular phone; can be costly. Long messages can lead to unnecessary expenses and also, they current systems do not allow the user to repeat or rewind messages, for no cost.

Also, the exchange of phone numbers between two people is not possible without new features on different phones and not possible for people using various systems such as CDMA, TDMA or GSM types of technology for data and voice transmission. The solutions presented here take care of both of the issues described.

### SUMMARY OF THE INVENTION

The first part of the solution presented here, allows any two cellular phones to operate as simple short range; transmitters and receivers. The user of a phone may initiate the process of transmitting his telephone number by entering into local transmit mode, and the user of another phone may try to pick up the number which is sent in a burst signal, by entering into local receive mode. Upon completion of reception, the number can be stored. This feature requires simple modification to existing technologies used in phones and doe not have the shortcoming of variations in technology from phone to phone.

The second idea is to use a phone to retrieve messages. Currently users use a phone to listen to messages remotely and they have option of entering DTMF tones to play back, rewind and even erase the messages from an answering machine or centralized voice mail system. The process is simple, but it is costly. The solution presented here, allows the user to download the messages into the cellular phone or other phones and also since the messages are sent in MP3 or other formats, the transmission time is reduced by a fact of 5 or better, and as a result the cost of long distance or cellular time usage is reduced drastically.

### BRIEF DESCRIPTION OF DRAWINGS

FIG. 1. Shows a block diagram of key elements of the system design for a message retrieval system using answering machine or a centralized computer based systems, showing hardware and software/firmware related parts.

FIG. 2 shows a typical hand phone device.

Table 1. shows a command set, with equivalent DTMF-based tones required for specific commands.

FIG. 3 shows the flow chart for operation of two phones in local mode for exchanging phone numbers.

FIG. 4 shows the flowchart for the software as needed for remote message retrieval from an answering machine or a centralized voice mail system.

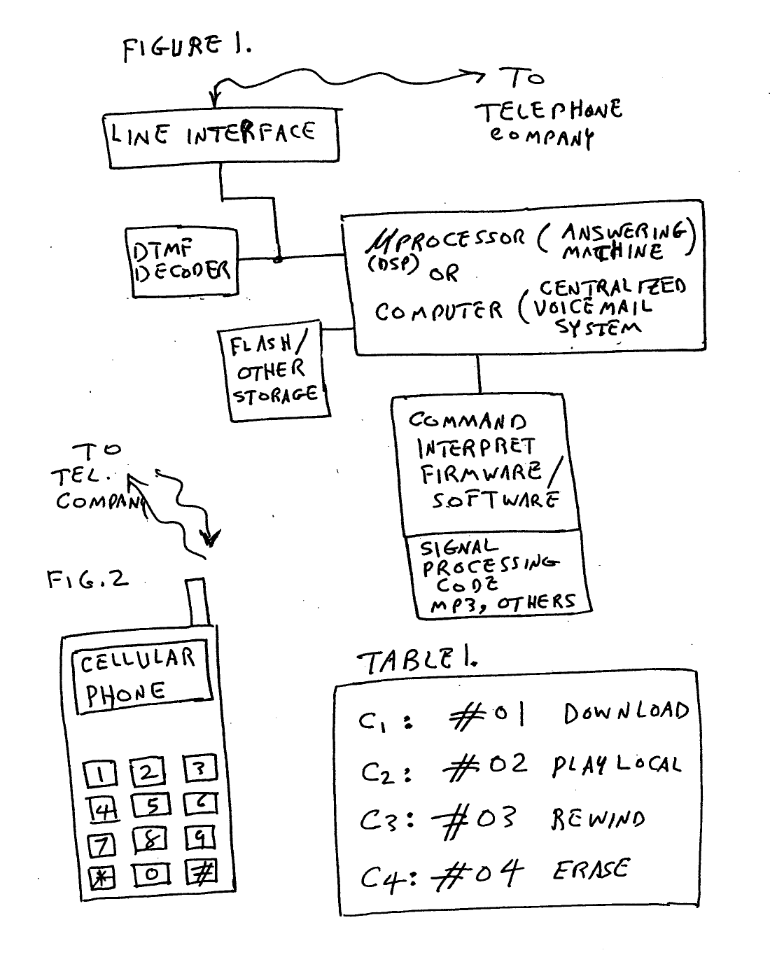

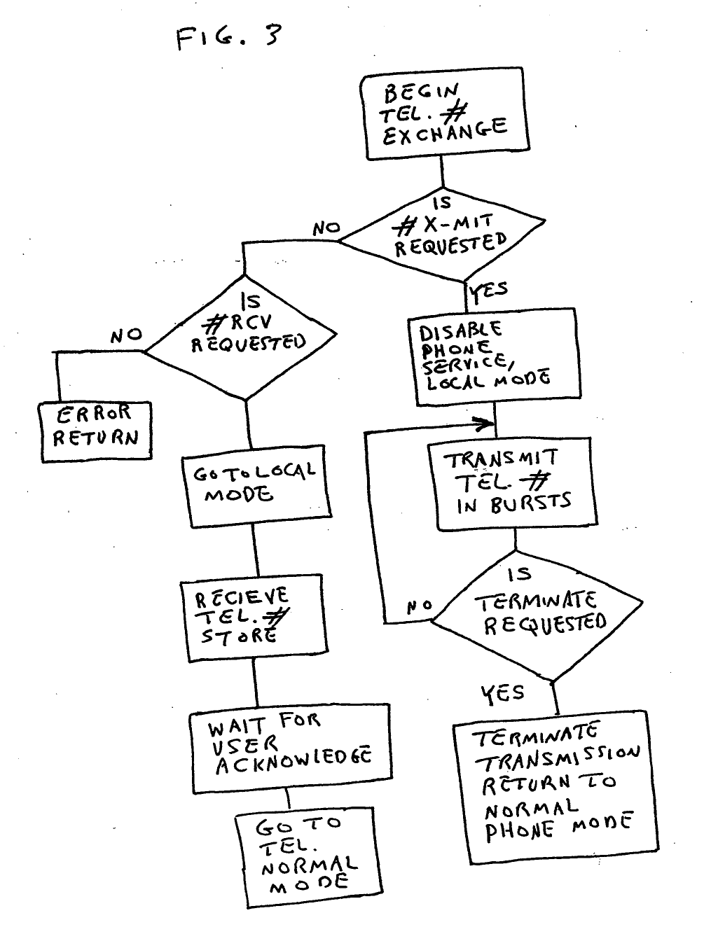

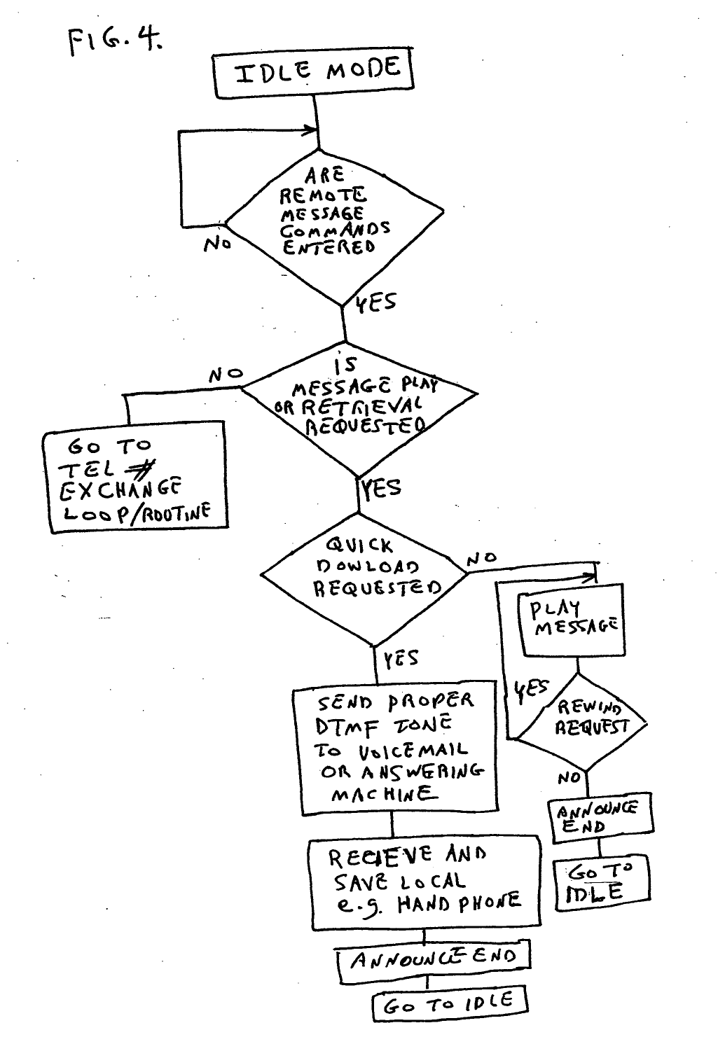

I claim:

1. A cellular phone design modification in hardware and firmware which allows the phone to operate in local mode and act as simple transmitters and receivers for either sending own number or receiving the others' numbers in simple manner by user entering simple commands.

2. A modified design of cellular phones to have local memory for downloading messages from answering machines and computerized voice mail systems, in MP3 or other formats which will allow fast downloading of the messages and their playback along with a voicemail system software modification and answering systems/systems that allow the creation or conversion of voice messages in MP3 or other formats for quick transfer over the phone lines.
